(19) United States
(12) Patent Application Publication
(10) Pub. No.: US 2003/0134766 A1
(43) Pub. Date: Jul. 17, 2003

(54) Fabric conditioning kit

(75) Inventors: Craig Warren Jones, Bebington (GB); Leslie Joseph Joinson, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/336,319

(22) Filed: Jan. 3, 2003

(30) Foreign Application Priority Data
Jan. 4, 2002 (GB) 0200154.3

(51) Int. Cl. C11D 17/00

(52) U.S. Cl. 510/293; 510/438; 510/296; 510/392

(57) ABSTRACT

A fabric conditioning kit comprises a water-soluble package for containing a liquid rinse conditioning composition and an activator provided separately from the water-soluble package and comprising an active ingredient which causes and/or accelerates the disintegration of the water-soluble polymeric film. The package is placed into the washing machine drum at the beginning of the wash cycle and the activator is placed in the rinse compartment of the dispensing drawer.

### FIELD OF THE INVENTION

The present invention relates to a fabric conditioning kit and a method of conditioning fabrics.

### BACKGROUND AND PRIOR ART

Conventionally, rinse conditioning compositions are provided as a liquid in a plastics bottle which requires the consumer to dose the correct amount of the fabric softening composition from the bottle into the dispensing drawer of a washing machine.

The problem with conventional liquid fabric softeners provided in a bottle or other such package is that there is always a risk of underdosing or overdosing the rinse conditioning composition into the dispenser drawer of a washing machine resulting in a unsatisfactory or undesired level of softening being provided to fabrics. There is also the problem of spillage of the ingredients when pouring the product from the package into the dispensing drawer of a washing machine.

Therefore, it is desirable to provide a rinse conditioning composition which is convenient to use and guarantees that the correct amount of fabric softening composition is dosed into the rinse cycle. It is also desirable to avoid the problem of spillage of the product associated with the dispensing of conventional rinse conditioners from a bottle or the like.

Water-soluble packages are known in the detergent and agrochemical industries and generally comprise either vertical form-fill-seal (VFFS) envelopes or thermoformed envelopes. In one of the VFFS processes, a roll of water-soluble film is sealed along its edges to form a tube, which tube is heat sealed intermittently along its length to form individual envelopes which are filled with product and heat sealed. The thermoforming process generally involves moulding a first sheet of water-soluble film to form one or more recesses adapted to retain a composition, such as for example a solid agrochemical composition, placing the composition in the at least one recess, placing a second sheet of water-soluble material over the first so as to cover the or each recess, and heat sealing the first and second sheets together at least around the recesses so as to form one or more water-soluble packages.

Cleaning products are traditionally often liquids, viscous or thin, such as known for personal cleaning (bath and shower liquids and shampoos) or for domestic cleaning (hand dish wash and other hard surface cleaning, laundry-cleaning etc.). Other products are solids, such as powders, granules, small capsules (up to 2 mm diameter) or more recently tablets, for laundry and machine dish wash, and soap bars for skin cleaning. Recently, so called unit dose products are experiencing an increasing success with consumers, because they eliminate the need for manipulating, and possibly spilling, liquids or powders and simplify the use of a correct dose of the product for the required purpose. Examples thereof are the laundry and machine dish wash tablets mentioned above and recently described in F. Schambil and M. Böcker, Tenside Surf. Det. 37 (2000) 1.

Many types of water-soluble packages are known, including packages made from polyvinyl alcohol (hereinafter referred to as “PVOH”) film. A wide variety of different materials can be packaged in such films, including liquid materials. EP-A-518689 discloses a containerisation system for hazardous materials (for example pesticides) comprising a PVOH film enclosing a composition comprising the hazardous material, water, an electrolyte and optional other materials. The electrolyte is added to reduce the solubility of the film to prevent its dissolution by the packaged composition.

EP-B-389513 discloses concentrated aqueous syrups (mainly foodstuffs but other materials such as detergents are mentioned) inside PVOH packages, the concentration of the syrup being effective to prevent dissolution of the package by the packaged composition.

EP-A-700989 discloses a unit packaged detergent for dish washing, the package comprising a detergent composition wrapped in PVOH film, wherein the film protects the detergent from dissolution until the main wash cycle of the dish washing machine.

EP-A-941939 relates to a water-soluble package, which can be PVOH, containing a composition which, when dissolved, produces a solution of known composition.

EP-B-160254 relates to a washing additive comprising a mixture of detergent constituents in a PVOH bag. The detergent comprises nonionic surfactant and a quaternary ammonium compound.

A variety of water-soluble PVOH films are also known. For example, EP-B-157162 relates to a self-supporting film comprising a PVOH matrix having rubbery microdomains dispersed therein.

WO-A-96/00251 relates to an amphipathic graft copolymer comprising a hydrophobic backbone with grafting sites to which are grafted a hydrophilic polymer prepared from a hydrophilic monomer containing stabilising pH independent ionic groups.

WO-A-97/00282 relates to a water-soluble film combining two polymeric ingredients S and H where S is a soft acid-functional olefinic addition copolymer having a Tg less than 20° C. and H is a hard acid-functional olefinic addition copolymer having a Tg less than 40° C. The ratio of S:H is from 90:10 to 65:35 and the acid functionalities are at least partially neutralised to render the film water-soluble.

EP-B-79712 relates to a laundry additive for discharge to a wash containing borate ions. The additive is enclosed within a film of PVOH which is plasticised and has as a solubiliser either a polyhydroxy compound (such as sorbitol) or an acid (such as polyacrylic acid).

EP-B-291198 relates to a water-soluble film containing an alkaline or borate-containing additive. The film is formed from a copolymer resin of vinyl alcohol having 0-10 mole % residual acetate groups and 1-6 mole % of a non-hydrolysable anionic comonomer.

A PVOH package containing a liquid laundry detergent composition comprising from about 10% to about 24% by weight of water (but 3.57% in the sole example) is disclosed in U.S. Pat. No. 4,973,416.

More recently, it has become a common practise to dose a detergent directly into the drum of a washing machine rather than via a dispensing drawer as this can provide the benefit of ensuring that the detergent is fully mixed with the fabrics being laundered and avoids the risk of undesirable residues remaining in the dispensing drawer and/or an insufficient amount of detergent being transferred from the dispensing drawer to the drum.

For the same reason, it is desirable to provide a water-soluble package which can be introduced into the drum at the beginning of the wash cycle but remains intact until the rinse cycle so as to deliver all of the rinse treatment product to the rinse cycle.

This problem is addressed in our co-pending application GB 0114847.7 where a polymeric film is modified by the inclusion of a modifying protective functional group which protects the polymeric film during the wash cycle but which is designed to allow the polymeric film to break down during the rinse cycle.

However, this relies on the wash/rinse liquor conditions changing substantially between the wash cycle and the rinse cycle so as to initiate the disintegration of the polymeric film.

Thus, it is desirable to be able to control more effectively the disintegration of the water-soluble package so as to ensure that it remains intact during the wash cycle but disintegrates sufficiently during the rinse cycle.

### OBJECTS OF THE INVENTION

The present invention seeks to address one or more of the above-mentioned problems and/or to provide one or more of the above-mentioned benefits.

### SUMMARY OF THE INVENTION

According to the present invention, there is provided a fabric conditioning kit comprising:

(i) a water-soluble package for containing a liquid rinse conditioning composition; and

(ii) an activator

wherein the activator is provided separately from the water-soluble package and comprises an active ingredient which accelerates the disintegration of the water-soluble polymeric film.

Preferably the active ingredient comprises one or more of an acid, a ligand and an enzyme.

According to the further aspect of the invention, there is provided a method of conditioning fabrics in a washing machine laundry treatment process comprising:

(i) dosing a water-soluble package containing a conditioning composition into a washing machine drum before the wash cycle commences

(ii) dosing an activator into a rinse compartment of the dispenser drawer of the washing machine before the rinse cycle commences,

(iii) operating the machine to provide a wash cycle followed by a rinse cycle so that at least part of the activator is transferred from the rinse compartment to the drum during the rinse cycle thereby causing and/or accelerating the disintegration of the water-soluble package during the rinse cycle and release of the conditioning composition therefrom; and

(iv) contacting the conditioning composition with fabrics during the rinse cycle.

Of course, steps (i) to (iv) do not necessarily occur in the order specified. For instance, the operation of the machine may be started before the activator is dosed into the rinse compartment.

### DETAILED DESCRIPTION OF THE INVENTION

The invention relates to a fabric conditioning kit comprising a water-soluble package and an activator for causing and/or accelerating the disintegration of the package.

The Water-Soluble Package

Any water-soluble film forming polymer which is compatible with formulations defined below for use in the invention can be employed in the present invention.

By “water-soluble” it is meant that the polymeric film is soluble under rinse cycle conditions but substantially insoluble under normal machine wash cycle conditions.

Suitable polymeric films which are resistant to disintegration during the wash cycle are described in our co-pending application GB 0114847.7, the content of which insofar as it relates to water-soluble polymeric films, is incorporated herein.

The Water-Soluble Polymer Film

Preferred water-soluble polymers are those capable of being cast into a film or solid mass and may for example as described in Davidson and Sittig, Water-Soluble Resins, Van Nostrand Reinhold Company, New York (1968). The water-soluble polymer should have proper characteristics, such as strength and pliability, to permit machine handling.

The water-soluble resin film should be formulated so as to remain substantially intact during the main wash cycle of the washing machine operation. Preferably it should also be formulated to completely dissolve in water at the beginning of or during the rinse cycle although this is not essential as the activator is present for this purpose.

In the context of the present invention, “substantially intact” means that the film may dissolve or disperse partially but the contents thereof remain wholly within the film.

Preferred water-soluble resins include PVOH, cellulose ethers, polyethylene oxide (hereinafter referred to as “PEO”), starch, polyvinylpyrrolidone (hereinafter referred to as “PVP”), polyacrylamide, polyacrylonitrile, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose, and copolymers thereof. The film may comprise a single polymer or blends of different polymers.

All of the above polymers include the aforementioned polymer classes whether as single polymers or as copolymers formed of monomer units or as copolymers formed of monomer units derived from the specified class or as copolymers wherein those monomer units are copolymerised with one or more comonomer units.

Lower molecular weight water-soluble, PVOH film-forming resins are particularly preferred.

PVP films are advantageous in that they are clear, glossy, and reasonably hard at low humidity, although it is preferred that a water-insensitive modifier, such as 10% of an aryl-sulfonamide-formaldehyde resin, is incorporated into PVP films to reduce tackiness at higher humidity.

Preferred water-soluble films may also be prepared from polyethylene oxide (PEO) resins by standard moulding techniques such as calendering, casting, extrusion, and other conventional techniques. The polyethylene oxide films may be clear or opaque, and are inherently flexible, tough, and resistant to most oils and greases. These polyethylene oxide resin films provide better solubility than other water-soluble plastics without sacrificing strength or toughness. The excellent ability to lay flat, stiffness, and sealability of water-soluble polyethylene oxide films make for good machine handling characteristics.

PVOH Films

Generally, preferred water-soluble, PVOH film-forming polymers should have relatively low average molecular weight and low levels of hydrolysis in water. Polyvinyl alcohols preferred for use therein have an average molecular weight between 1,000 and 300,000, preferably between 2,000 and 100,000, most preferably between 2,000 and 75,000. Hydrolysis, or alcoholysis, is defined as the percent completion of the reaction where acetate groups on the resin are substituted with hydroxyl, —OH, groups. A hydrolysis range of from 60-99% of PVOH film-forming resin is preferred, while a more preferred range of hydrolysis is from about 70-90% for water-soluble, PVOH film-forming resins. The most preferred range of hydrolysis is 80-88%.

As used in this application, the term “PVOH” includes polyvinyl acetate compounds with levels of hydrolysis disclosed herein.

PVOH can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water-soluble packages are typically polymers produced from copolymerisation of vinyl acetate and another comonomer which contains a carboxylic function.

Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

Suitable PVOH films for use in a package according to the invention are commercially available and described, for example, in EP-B-0291198. PVOH films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

Cross-Linking Agent

In order to provide a water-soluble package which maintains integrity and structure during the wash cycle but which dissolves or disperses fully in the rinse cycle, it has been found advantageous for the water-soluble film to comprise a cross-linking agent.

Particularly suitable cross-linking agents include formaldehyde; polyesters; epoxides; isocyanates; vinyl esters; urethanes; polyimides; arylics with hydroxyl, carboxylic, isocyanate or activated ester groups; bis(methacryloxypropyl) tetramethylsiloxane (styrenes, methylmethacrylates); n-diazopyruvates; phenyboronic acids; cis-platin; divinylbenzene (styrenes, double bonds); polyamides; dialdehydes; triallyl cyanurates; N-(-2-ethanesulfonylethyl)pyridinium halides; tetraalkyltitanates; mixtures of titanates and borates or zirconates; polyvalent ions of Cr, Zr, Ti; dialdehydes, diketones; alcohol complexes of organotitanates, zircoates and borates and copper (II) complexes.

Most preferred as the cross-linking agent is boric acid or its salt form, e.g. sodium borate.

The level of cross-linking agent, if present, is from about 0.05% to 9% by weight of the film, more preferably 1% to 6%, most preferably about 1.5% to 5% by weight. The upper range will, of course, result in more cross-linking and a slower rate of dissolution or dispersion of the film in the rinse cycle.

Functionally, it is believed that the cross-linking agent reduces the solubility of the film polymer by increasing its effective molecular weight such that the polymer gels under the alkaline wash conditions. Generally the effective molecular weight of the gel state is about 2×10⁸ g/mole which gives a gel-product viscosity of about 100,000 mPa·s.

For PVOH films, the preferred cross-linking agent is a metalloid oxide such as borate, tellurate, arsenate, and precursors thereof. Other known cross-linkers are selected from a vanadyl ion, a titanium ion in the plus three valence state, or a permanganate ion (disclosed in U.S. Pat. No. 3,518,242). Other cross-linkers are given in the book: Polyvinylalcohol—Properties and applications, Chapter 9 by C. A. Finch (John Wiley & Sons, New York, 1973). The cross-linking agent can be present in the film itself and/or in the wash solution.

Additional Protective Layers

An protective layer, such as PTFE, may be present between the film polymer and the rinse conditioner composition. In such a case, it is possible for the rinse conditioner composition to comprise higher levels of water. Suitable water-soluble films coated with PTFE are disclosed in U.S. Pat. No. 4,416,791.

Such coated films are capable of maintaining structure and integrity even if the contents comprise a composition having a level of water of 30% by weight or more, even 50% by weight or more.

Plasticiser

The film preferably comprises plasticiser.

One or more plasticisers may independently be incorporated in the film and in the liquid composition. However, it is very much preferred for the identity of the plasticiser in the film and in the liquid composition to be substantially the same.

The plasticiser influences the way the polymer chains react to external factors such as compression and extensional forces, temperature and mechanical shock by controlling the way that the chains distort/realign as a consequences of these intrusions and their propensity to revert or recover to their former state. The key feature of the plasticiser is that it is highly compatible with the film. Typically it is hydrophilic in nature.

The preferred plasticiser will depend on the nature of the film in question.

Generally, plasticisers suitable for use with PVOH-based films have —OH groups in common with the —CH2-CH(OH)—CH2-CH(OH)— polymer chain of the film polymer.

Water itself is a suitable plasticiser for PVOH films but other common plasticisers include polyhydroxy compounds, such as glycerol, trimethylolpropane, diethylene glycol, triethylene glycol, dipropylene glycol; starches, such as starch ether, esterificated starch, oxidized starch and starches from potato, tapioca and wheat; cellulosics/carbohydrates, such as amylopectin, dextrin carboxymethylcelluose and pectin.

The preferred amount of plasticiser is from 0.001% to 10%, preferably from 0.005% to 4% by weight of the liquid contents of the water soluble package.

Encapsulation Methods

Any reference herein to filling refers to complete filling and also partial filling whereby some air or other gas is also trapped in the sealed envelope.

(a) Horizontal Form-Fill-Seal

Water-soluble packages based on PVOH can be made according to any of the horizontal form-fill-seal methods described in any of WO-A-00/55044, WO-A-00/55045, WO-A-00/55046, WO-A-00/55068, WO-A-00/55069 and WO-A-00/55415.

By way of example, a thermoforming process is now described where a number of packages according to the invention are produced from two sheets of water-soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of PVOH film is drawn over a forming die so that the film is placed over the plurality of forming cavities in the die. In this example each cavity is generally dome shape having a round edge, the edges of the cavities further being radiussed to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 50 kPa is pulled through the pre-heating plate to ensure intimate contact between the film and the pre-heating plate, this intimate contact ensuring that the film is heated evenly and uniformly (the extent of the vacuum is dependant of the thermoforming conditions and the type of film used, however in the present context a vacuum of less than 0.6 kPa was found to be suitable). Non-uniform heating results in a formed package having weak spots. In addition to the vacuum, it is possible to blow air against the film to force it into intimate contact with the preheating plate.

The thermoformed film is moulded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30 kg/cm², preferably 10 to 20 kg/cm². The raised flanges surrounding each cavity ensure that the films are sealed together along the flange to form a continuous seal. The radiussed edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

(b) Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

Encapsulation methods for other water-soluble films such as based on PVP or PEO will be known to those skilled in the art.

Unit Dose Volume

The amount of the substantially non-aqueous liquid product in each unit dose package may for example be from 0.5 ml to 100 ml, e.g. from 1 ml to 30 ml, preferably from 1.5 ml to 25 ml, more preferably from 2 ml to 15 ml.

Activator

The fabric conditioning kit comprises an activator which causes and/or accelerates the disintegration of the water-soluble package.

The activator is selected for its compatibility with the film.

For instance, where a film is formulated so as to disintegrate in response to changes in the pH the wash environment, a pH-accentuating activator may be provided. Alternatively, for a film which disintegrates in response to changes in the ionic strength of the rinse liquor, the activator is formulated so as to change the ionic strength of the liquor more dramatically. A further alternative is, for instance, where the film comprises active groups which cause the film to disintegrate in the presence of certain enzymes. In such a case, the activator comprises the relevant enzymes.

The activator is provided within the kit separately from the water-soluble package. That is, the activator and water-soluble package are discrete from each other.

Whereas the water-soluble package is typically dosed directly into the drum of the washing machine, the activator is preferably dosed into the rinse compartment of the dispenser drawer of the washing machine.

Thus, the activator does not normally enter the rinse liquor until the rinse cycle commences.

The activator may be in the form of a solid or liquid material. If solid it can, for example, be granulated, powdered, tabletted, a foam or in the form of a bar or block. It is particularly preferred that the activator is in the form of a solid block or tablet as this can advantageously be constructed either as a single use activator where all of the block or tablet disintegrates and is delivered to the rinse liquor in one laundry cycle or as a multiple use activator where only part of the activator block or tablet disintegrates and is delivered to the rinse liquor.

A typical activator comprises one or more of the following active materials which individually or in combination cause and/or accelerate the disintegration of the water-soluble package during the rinse cycle:

ligands

acids

enzymes

Ligands

A ligand may be present which bonds with functional groups on the polymeric film and causes the film to become soluble during the rinse cycle.

The ligand is preferably a bi- or polydentate ligand. Suitable ligands include 1,2-ethanediol, glycolic acid, lactic acid, sucrose, poly(vinylalcohol), oxalic acid, glycerol, citric acid or combinations thereof.

Where the active ingredient of an activator comprises a ligand, it is especially preferred that the polymeric film is cross-linked, e.g. with a metalloid oxide cross-linking agent.

In a preferred embodiment, the activator is a solid material comprising a ligand in an amount from to 0.5 to 40% by weight of the total weight of the activator, more preferably 1 to 20% by weight, most preferably 1 to 10% by weight.

Acids

The pH of the wash environment typically more acidic during the rinse cycle than the wash cycle, and it is desirable that the film is responsive to such a change. Thus, the active ingredient may be an acid which reduces the pH of the rinse liquor and accentuates the pH drop from the wash cycle to the rinse cycle so as to accelerate disintegration of acid-sensitive water-soluble packages.

It is particularly preferred that where the active ingredient of the activator is an acid, the water-soluble polymeric film comprises functional groups which provide the film with significantly increased solubility when the pH is reduced from the wash cycle to the rinse cycle.

Suitable functional groups which significantly increase solubility of the polymeric film at lower pH values include, for example, amides, orthoesters, acetals, hemi-acetals and primary, secondary and tertiary amines.

Polymeric films complexed with cross-linking agents, such as described above, are also found to be particularly susceptible to a pH reduction of the environment and thus are especially suited for use with an acid-based activator.

The acid may be an inorganic or organic acid. Suitable acids include, for instance, sodium hydrogen sulphate, hydroxycitric acid, sodium hydrogen carbonate, potassium hydrogen tartrate, potassium dihydrogen citrate, sodium hydrogen diglyconate, hydrochloric acid, methane sulphonic acid, toluene sulphonic acid, potassium tetroxalate and short chain organic acids such as propionic and acetic acid.

In a preferred embodiment, the activator is a solid material comprising an acid in an amount from to 2 to 60% by weight of the total weight of the activator, more preferably 2 to 30% by weight, most preferably 2 to 15% by weight.

Enzymes

Enzymes are also suitable as the active ingredient in an activator.

Particularly preferred enzymes are those which transform the functional groups on the polymeric film by for example, hydrolysis, oxidation and/or reduction. To this end, mixtures of enzymes may be employed in the activator.

For instance, enzymes such as lipase BCC can increase the rate of hydrolysis of ester groups within a water-soluble polymeric film and esterases and proteases hydrolyse acyl groups within a fatty acylated PVOH film.

Nitrilase enzymes can be used to hydrolyze cyano groups to carboxylic acid groups thus rendering soluble the water insoluble cyano-containing polymeric film.

For example, acrylonitrile homo- or co-polymers with vinyl acetate are insoluble in water but the use of nitrilase enzymes causes hydrolysis of the nitrile functions to carboxylic acids rendering the polymer soluble in the aqueous media.

Other suitable enzymes are those isolated from Rhodococcus sp., and Rhodococcus butanica.

Where the active ingredient in an activator is an enzyme, it is preferred that the activator is a porous solid support such as alumina or zeolite containing the immobilized enzyme, which is released with pH buffers during the rinse to hydrolyze the esters within the polymeric film.

The activator may comprise a single active material or a combination of active materials, e.g. an acid and a ligand.

Optional Activator Ingredients

The activator may include ingredients to assist formation of the activator in the desired form, i.e. liquid or solid. For instance, a solid tablet preferably also contains glycerol, citric acid, water and is formed by the standard compression or moulding techniques used for forming a detergent tablet.

Rinse Conditioning Composition

Preferably the rinse conditioning composition is substantially non-aqueous so as to be compatible with the water-soluble polymeric film.

In the context of the present invention, “substantially non-aqueous” means that the level of water or other aqueous components in the rinse conditioner composition is 10% by weight or less of the total weight of the rinse conditioner composition, more preferably 5% or less by weight, most preferably 3% or less by weight.

However, if a protective layer is present between the film and the rinse conditioner composition, it is possible for the rinse conditioning composition to be a conventional aqueous rinse conditioner, comprising more than 10% by weight of water.

If the composition is substantially non-aqueous it may be in any suitable form, such as substantially non-aqueous concentrated melts, concentrated emulsions and microemulsions.

For the purposes of the present invention, a substantially non-aqueous concentrated melts is defined as a fabric conditioning composition present in solid form, such as particles, at a specified temperature, the solid being suspended in an oil matrix and containing less than 10 wt %, preferably less than 5 wt % of water.

A substantially non-aqueous concentrated rinse conditioner emulsion is defined as a mixture of a quaternary ammonium softening material, an oil and water comprising more than 10 wt % of the quaternary ammonium material and less than 10 wt % of water.

A substantially non-aqueous microemulsion is defined as a composition comprising less than 10% by weight water, wherein the composition is clear, isotropic and thermodynamically stable across a range of temperatures.

The following conventional ingredients are optionally present in the rinse conditioning compositions.

Quaternary Ammonium Fabric Softening Material

The quaternary ammonium fabric softening material generally comprises one or more fatty hydrocarbyl chains attached to a nitrogen headgroup.

Preferably, the average length of the hydrocarbyl chain is at least C₁₄, more preferably at least C₁₆. Most preferably at least half of the chains have a length of C₁₈.

It is generally preferred that the hydrocarbyl chain is predominantly linear.

It is especially preferred that the softening material comprises a compound having two C₁₂₋₁₈ alkyl or alkenyl groups connected to the nitrogen head group via at least one ester link. It is more preferred if the quaternary ammonium material has two ester links present.

A first group of preferred ester-linked cationic surfactant materials for use in the invention is represented by formula (I):

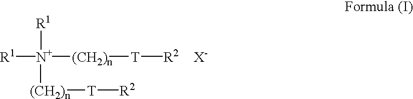

wherein each R¹ group is independently selected from C₁₋₄ alkyl or C₂₋₄ alkenyl groups; and wherein each R² group is independently selected from C₈₋₂₈ alkyl or alkenyl groups;

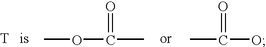

X⁻ is any anion compatible with the cationic surfactant, such as halides or alkyl sulphates, e.g. chloride, methyl sulphate or ethyl sulphate and n is 0 or an integer from 1-5.

A second preferred softening material for use in the invention is represented by formula (II):

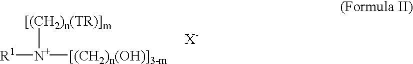

wherein each R is independently selected from a C₅₋₃₅ alkyl or alkenyl group, R¹ represents a C₁₋₄ alkyl or hydroxyalkyl group or a C₂₋₄ alkenyl group, m is 1, 2 or 3 and denotes the number of moieties to which it refers that pend directly from the N atom and T, n and X⁻ are as defined above.

Especially preferred materials within this formula are di-alkenyl esters of triethanol ammonium methyl sulphate and N-N-di(tallowoyloxy ethyl) N,N-dimethyl ammonium chloride. Commercial examples of compounds within this formula are Tetranyl® AOT-1 (di-oleic ester of triethanol ammonium methyl sulphate 80% active), AO-1 (di-oleic ester of triethanol ammonium methyl sulphate 90% active), Tetranyl® AHT-1 (di-hardened tallowyl ester of triethanol ammonium methyl sulphate 85% active), L1/90 (partially hardened tallow ester of triethanol ammonium methyl sulphate 90% active), L5/90 (palm ester of triethanol ammonium methyl sulphate 90% active (supplied by Kao corporation); Rewoquat WE15 (C₁₀-C₂₀ and C₁₆-C₁₈ unsaturated fatty acid reaction products with triethanolamine dimethyl sulphate quaternised 90% active), WE18 and WE20 (both are partially hardened tallow ester of triethanol ammonium methyl sulphate 90% active), ex Goldschmidt Corporation; and Stepantex VK-90 (partially hardened tallow ester of triethanol ammonium methyl sulphate 90% active), ex Stepan Company.

A third preferred type of quaternary ammonium material is represented by formula (III):

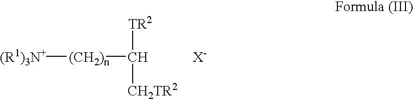

wherein R¹, R², n, T and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A fourth preferred type of quaternary ammonium material is represented by formula (IV):

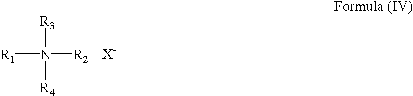

where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl) dimethyl ammonium methyl sulphate, dihexadecyl dimethyl ammonium chloride, di(hardened tallow alkyl) dimethyl ammonium chloride, dioctadecyl dimethyl ammonium chloride and di(coconut alkyl) dimethyl ammonium chloride.

The softening material is preferably present in an amount from 2 to 60% by weight of the active ingredient, more preferably 2.5 to 30% by weight, most preferably 3-25% by weight, based on the total weight of the composition.

Preferred softening materials are substantially water insoluble.

‘Substantially water insoluble’ surfactant compounds in the context of this invention are defined as compounds having a solubility less than 1×10⁻³ wt % in demineralised water at 20° C. Preferably the cationic surfactants have a solubility less than 1×10⁻⁴. Most preferably the cationic surfactants have a solubility at 20° C. in demineralised water from 1×10⁻⁸ to 1×10⁻⁶ wt %.

Oily Sugar Derivatives

The rinse conditioner compositions may comprise an oily sugar derivative.

The oily sugar derivative is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

The rinse conditioner composition may comprise from 0.5%-90 wt % of the oily sugar derivatives, more preferably 5-80 wt %, most preferably 10-60 wt %, based on the total weight of the composition.

Formulation and Dispersion Aids

The formulation aid is substantially non-aqueous and comprises one or more of the following components:

nonionic stabilising agents;

polymeric stabilisers;

single long hydrocarbyl chain cationic surfactants;

long chain fatty alcohols or acids;

short chain alcohols or oils; and

inorganic and/or organic electrolytes

Nonionic Stabilising Agents

The nonionic stabilising agents suitable for use in the rinse conditioner compositions include any of the alkoxylated materials of the particular type described hereinafter can be used as the nonionic surfactant.

Substantially water-soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above or can be hydrogen; and Z is at least about 8, preferably at least about 10 or 11.

Z denotes the average numbers of alkoxy moieties per molecule.

Especially preferred nonionic stabilising agents are alkoxylated nonionic fatty alcohols, such as C₁₀-C₂₂ alkyl/alkenyl fatty alcohols alkoxylated with 3-30, more preferably 5-25, most preferably 10-20 alkoxy moieties per molecule. The fatty alcohols may be alkoxylated with ethylene oxide, propylene oxide or ethylene oxide/propylene oxide mixtures.

Polymeric Stabilisers

Suitable polymeric stabilisers includes compounds having at least 2% by weight of water-soluble groups either within the main polymer backbone or pendant thereto.

Examples of polymeric within this class include PVA; polylactones such as polycaprolactone and polylactide; methyl cellulose; derivativised starches; derivatives of cellulose; and cationic polymers such as Guar Gum.

If present, it is desirable to incorporate such polymers at a level of from 0.01 to 5%, more preferable 0.05 to 3.5%, most preferably from 1 to 2% by weight of the polymer based on the total weight of the composition.

Single Long Hydrocarbyl Chain Cationic Surfactants

The compositions of the invention optionally contain a single long hydrocarbyl chain cationic surfactant.

The single long hydrocarbyl chain cationic surfactant are particularly suitable for use in emulsions since they can be employed in the formulation to aid the dispersion characteristics of the emulsion and/or to emulsify the composition, in order to form a macroemulsion having oil droplets which are smaller than those in macroemulsion compositions comprising the cationic fabric softening agent alone.

The single long chain cationic surfactant is preferably a quaternary ammonium compound comprising a hydrocarbyl chain having 8 to 40 carbon atom, more preferably 8 to 30, most preferably 12 to 25 carbon atoms (e.g. quaternary ammonium compounds comprising a C₁₀₋₁₈ hydrocarbyl chain are especially preferred).

Examples of commercially available single long hydrocarbyl chain cationic surfactants which may be used in the compositions of the invention include; ETHOQUAD (RTM) 0/12 (oleylbis(2-hydroxyethyl)methylammonium chloride); ETHOQUAD (RTM) C12 (cocobis(2-hydroxyethyl)methyl ammonium chloride) and ETHOQUAD (RTM) C25 (polyoxyethylene(15)cocomethylammonium chloride), all ex Akzo Nobel; SERVAMINE KAC (RTM), (cocotrimethylammonium methosulphate), ex Condea; REWOQUAT (RTM) CPEM, (coconutalkylpentaethoxymethylammonium methosulphate), ex Witco; cetyltrimethylammonium chloride (25% solution supplied by Aldrich); RADIAQUAT (RTM) 6460, (coconut oil trimethylammonium chloride), ex Fina Chemicals; NORAMIUM (RTM) MC50, (oleyltrimethylammonium chloride), ex Elf Atochem.

The single long hydrocarbyl chain cationic surfactant is preferably present in an amount from 0 to 5% by weight, more preferably 0.01 to 3% by weight, most preferably 0.5 to 2.5% by weight, based on the total weight of the composition.

Long Chain Fatty Alcohols, Acids or Oils

The formulation aid may further be selected from fatty alcohols, acids or oils, for example C8 to C24 alkyl or alkenyl monocarboxylic acids, alcohols or polymers thereof and C₈ to C₃₅ oils. Preferably saturated fatty acids or alcohols are used, in particular, hardened tallow C₁₆ to C₁₈ fatty acids.

Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated and superconcentrated compositions may comprise from 0.5 to 20% by weight of fatty acid, more preferably 1% to 10% by weight.

Suitable fatty acids include stearic acid (PRIFAC 2980), myristic acid (PRIFAC 2940), lauric acid (PRIFAC 2920), palmitic acid (PRIFAC 2960), erucic acid (PRIFAC 2990), sunflower fatty acid (PRIFAC 7960), tallow acid (PRIFAC 7920), soybean fatty acid (PRIFAC 7951) all ex Unichema; azelaic acid (EMEROX 1110) ex Henkel.

The fatty acid may also act as a co-softener in the rinse conditioner composition.

The formulation aid may comprise a long chain oil. The oil may be a mineral oil, an ester oil, a silicone oil and/or natural oils such as vegetable or essential oils. However, ester oils or mineral oils are preferred.

The ester oils are preferably hydrophobic in nature. They include fatty esters of mono or polyhydric alcohols having from 1 to 24 carbon atoms in the hydrocarbon chain, and mono or polycarboxylic acids having from 1 to 24 carbon atoms in the hydrocarbon chain, provided that the total number of carbon atoms in the ester oil is equal to or greater than 8, and that at least one of the hydrocarbon chains has 12 or more carbon atoms.

Suitable ester oils include saturated ester oils, such as the PRIOLUBES (ex. Unichema). 2-ethyl hexyl stearate (PRIOLUBE 1545), neopentyl glycol monomerate (PRIOLUBE 2045) and methyl laurate (PRIOLUBE 1415) are particularly preferred although oleic monoglyceride (PRIOLUBE 1407) and neopentyl glycol dioleate (PRIOLUBE 1446) are also suitable.

It is preferred that the viscosity of the ester oil is from 0.002 to 0.4 Pa·S (2 to 400 cps) at a temperature of 25° C. at 106 s⁻¹, measured using a Haake rotoviscometer NV1, and that the density of the mineral oil is from 0.8 to 0.9 g·cm⁻³ at 25° C.

Suitable mineral oils include branched or straight chain hydrocarbons (e.g. paraffins) having 8 to 35, more preferably 9 to 20 carbon atoms in the hydrocarbon chain.

Preferred mineral oils include the Marcol technical range of oils (ex Esso) although particularly preferred is the Sirius range (ex Silkolene) or Semtol (ex Witco Corp.). The molecular weight of the mineral oil is typically within the range 100 to 400.

One or more oils of any of the above mentioned types may be used.

It is believed that the oil provides excellent perfume delivery to the cloth and also increases perfume longevity upon storage of the composition.

The oil may be present in an amount from 0.1 to 40% by weight, more preferably 0.2-20%, by weight, most preferably 0.5-15% by weight based on the total weight of the composition.

Short Chain Alcohols

The formulation aid may comprise a short chain alcohol. Preferred are low molecular weight alcohols having a molecular weight of preferably 180 or less. The alcohol may be mono or polyhydric.

The presence of the lower molecular weight alcohol helps improve physical stability upon storage by lowering the viscosity to a more desired level and also assists the formation of the micro-emulsion. Examples of suitable alcohols include ethanol, isopropanol, n-propanol, dipropylene glycol, t-butyl alcohol, hexylene glycol, and glycerol.

The alcohol is preferably present in an amount from 0.1% to 40% by weight, more preferably from 0.2% to 35%, most preferably 0.5 to 20% by weight based on the total weight of the composition.

Inorganic and/or Organic Electrolytes

The fabric softening composition optionally comprises an electrolyte.

The electrolyte may be an inorganic or organic electrolyte.

Preferably the electrolyte is present in an amount from 0.001 to 1.5%, more preferably 0.01 to 1%, most preferably 0.02 to 0.7% by weight based on the total weight of the composition.

Suitable inorganic electrolytes include sodium sulphate, sodium chloride, calcium(II) chloride, magnesium(II) chloride, potassium sulphate and potassium chloride.

Suitable organic electrolytes include sodium acetate, potassium acetate, sodium citrate, potassium citrate and sodium benzoate.

The electrolyte improves viscosity control (especially viscosity reduction) of the compositions and assists dispersion of the composition.

Co-Active Softening Surfactants

Co-active softening surfactants for the cationic surfactant may also be incorporated in an amount from 0.01 to 20% by weight, more preferably 0.05 to 10%, based on the total weight of the composition. Preferred co-active softening surfactants are fatty amines, fatty acids and fatty N-oxides.

Perfume

The perfume may be any perfume conventionally used in fabric softening compositions, although it is particularly desirable that the perfume is lipophilic. It is especially preferred that the perfume has a solubility in water of no more than 10 g, preferably no more than 0.5 g, most preferably no more than 0.3 g per litre at 20° C.

Typical perfume ingredients suitable for use in the composition are as disclosed in ‘Perfume and Flavour Chemicals’ by Steffen Arctander (published by the author, Library of Congress catalogue card no. 75-91398).

The perfume is preferably present at a level from 0.01 to 20%, more preferably from 0.05 to 17%, most preferably from 1 to 10%, e.g. 2 to 6% by weight based on the total weight of the composition.

Other Optional Ingredients

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, pearlescers, anti-shrinking agents, anti-wrinkle agents, anti-spotting agents, germicides, fungicides, anti-corrosion agents, drape imparting agents, anti-static agents, ironing aids and dyes.

The rinse conditioner is substantially, and preferably entirely, free of anionic detergent surfactants conventionally used as an active cleaning ingredient in a main wash detergent product.

Preparation of the Rinse Conditioner Composition

The compositions of the invention may be prepared according to any suitable method.

In a first method, a melt is prepared by heating a reaction vessel to at least 50° C., adding an oil and a nonionic surfactant to the vessel and stirring the mixture. A cationic surfactant and a fatty acid and/or a long or short chain alcohol and then added to the vessel, and the stirring rate is increased. Stirring is continued until a homogenous mixture is formed.

The mixture is then left to cool to ambient temperature, under continuous stirring. Optionally perfume and/or a polymeric structurant (such as disclosed in our co-pending application PCT/EP99/0049) is then stirred into the mixture.

In a second method, a microemulsion is prepared by mixing under low agitation an oil, a solvent such as a low molecular weight alcohol, a dispersibility aid such as a nonionic surfactant, a cationic surfactant and 10% by weight or less of water until a clear composition is formed. In order to assist formation of the clear microemulsion, the mixture may be heated as required. Perfume may optionally be added to the mixture at any stage.

In a third method, a concentrated emulsion is prepared by heating water to a temperature above 50° C., adding an emulsifier, premixing a cationic surfactant, nonionic surfactant and oil and adding this to the water. Optionally the product is milled and then allowed to cool. Once below 50° C., perfume may be added.

Composition pH

When the composition is dispersed in water, the solution preferably has a pH of from 1.5 to 5, more preferably from 2 to 4.5, most preferably from 2.2 to 3.5.

Product Use

The water-soluble package is preferably disposed in the drum of the washing machine at the beginning of the wash cycle and the activator is disposed in the rinse compartment of the dispensing drawer.

A typical laundry cycle involves loading the fabrics to be treated into the drum together with the detergent and the water-soluble package containing the fabric conditioning composition. The activator is placed into the dispensing drawer. A laundry cycle is then selected and commences during which the detergent is used during the wash cycle while the water-soluble package remains intact. After the wash cycle the rinse cycle commences and the activator is at least partly transported from the rinse compartment of the dispenser drawer into the drum. The activator then causes the accelerated disintegration of the water-soluble package so as to allow the release of the contents of the water-soluble package during the rinse cycle.

### EXAMPLES

The invention will now be illustrated by the following non-limiting examples. Further modification within the scope of the present invention will be apparent to the person skilled in the art.

### Example 1

### Preparation of a Kit for Combined Activation Film

The following example is of a kit for use in increasing the rate of release of a non-aqueous rinse conditioner from a borate PVOH film via increased complexation or acidification.

An activator was prepared from the following ingredients:

TABLE 1

| Ingredient | Amount (grams) |
|---|---|
| Ethyl cellulose | 5 |
| Glycerol | 2 |
| Ligand (1) | 2 |
| Acid (2) | 1 |
| Magnesium stearate | 2 |
| Salt (3) | 1 |
| Silica | 0.5 |
| Water | 3 |

(1) 1,2-ethanediol
(2) propionic acid
(3) sodium chloride

The ingredients were granulated and compressed into tablets.

The tablet was placed in the rinse drawer of a front-loading automatic washing machine.

A polymeric film was formed as follows:

PVOH resin (ex Clariant) was added to demineralized water. An aqueous solution of boric oxide cross-linker was then added at a level of 0.01 to 2wt % of the solution. The resulting solution was heated to 90° C. until the PVOH dissolved fully. The solution was then cooled, degassed, poured onto a tray and allowed to evaporate to provide a film of thickness between 3 μm and 400 μm.

The film laminate was made by double casting and formed into a pouch by overlaying two sheets and heat sealing the edges of three sides. The pouch was filled with a 25 g of a rinse aid comprising 96% Tetranyl AOT-1 (a diester quaternary ammonium fabric softening material, ex Kao) and 4% perfume and the remaining edge heat sealed. The water soluble package was then placed in the drum of a Miele Novotronic W820 washing machine and a 40° C. cotton cycle was run.

Visual inspection of the package at the end of the wash cycle showed that it was still fully intact. During the rinse cycle the entire activator dissolved and the package disintegrated rapidly.

### Example 2

### Acid Activation of Polyacrylate Films Containing a Rinse Aid

The activator of example 1 is used.

The polymeric film was prepared as follows:

18 g methyl methacrylate (MMA), 21 g N,N′-dimethylaminoethyl methacrylate (DMAEMA) and 21 g N,N′-dimethylaminopropyl methacrylic acid amide (DMAPMA) ex. Acros were charged to a 200 ml four necked flask equipped with stirrer, thermometer, reflux condenser, and nitrogen inlet. 50 g Toluene (double distilled) was added and the mixture stirred at 70° C. 0.72 g azobisbutyronitrile dissolved in 10 g doubly distilled toluene was then introduced, and the mixture stirred for 7 hours to provide a fully polymerized polyacrylate terpolymer.

The solution was cooled and slowly added to 2 litres of hexane to precipitate the polymer. The co-polymer was filtered at the pump, and washed with cold n-hexane. The polymer was then dried in vacuo at ambient for 24 hours, and ground.

1 g of the polyacrylate terpolymer powder was weighed into a 100 ml flask, 20 ml of absolute ethanol was added and the powder dissolved with stirring. When the polymer was fully dissolved, 0.1 g glycerol (98% extra pure, ex Lamers & Pleuger) was added and stirring continued for about 15 minutes.

A tray was prepared from blue Teflon tape (Furon Fluorglas, width 103 mm and length 150 mm) having its ends folded to provide a free area of 120 mm by 70 mm, or at least sufficient to provide a free area for film formation so that the film thickness of 200 μm was produced upon drying.

The tray was fixed onto a levelled table to provide stability of the tray and also to maintain uniformity in the dimensions of film. An enclosure was provided above the tray to limit excessive drying rate of solvent from the surface.

The film was formed as per example 1 to provide a polyacrylate film of thickness 100 μm. The film was then formed into a pouch, filled with a rinse conditioner and sealed as described in example 1.

The film was placed in an alkaline solution (pH 9) at 20° C. for 45 minutes. A visual inspection revealed that the water soluble package remained substantially intact.

The activator was added to the solution and the solution agitated. A pH drop below 8 was measured and the film was observed to dissolve rapidly.

### Example 3

### Ester Hydrolysis of Fatty Acyl Chains on PVOH Using an Enzyme Activator

A first enzyme-based activator was prepared by immobilising a lipase BCC enzyme on a porous alumina support.

A second enzyme-based activator was formed by forming a mixture comprising 20 wt % lipase, 50 wt % water-soluble buffer, 10 wt % cationic surfactant and 20 wt % methyl cellulose thickening agent. The mixture was then compacted into a tablet form.

A film was prepared by esterifying PVOH according to esterification techniques known in the art to produce a PVOH polymer having from 5 to 30% of fatty acyl bonds. The resulting polymer was cast as a film in a conventional manner.

The film was divided into 3 equal samples which were placed in first, second and third flasks containing demineralised water at 20° C. The first activator was placed in the second flask and the second activator in the third flask and it was observed that the rate of disintegration of the film in the second and third flasks was significantly greater than that in the first flask.

1. A fabric conditioning kit comprising:
(i) a water-soluble package for containing a liquid rinse conditioning composition; and
(ii) an activator
wherein the activator is provided separately from the water-soluble package and comprises an active ingredient which causes and/or accelerates the disintegration of the water-soluble polymeric film.

2. A kit according to claim 1 wherein the active ingredient of the activator comprises an acid.

3. A kit according to claim 1 wherein the active ingredient of the activator comprises a ligand.

4. A kit according to claim 1 wherein the active ingredient of the activator comprises an enzyme.

5. A kit according to claim 1 wherein the activator is a solid.

6. A kit according to claim 5 wherein the activator is a tablet.

7. A kit according to claim 1 wherein the water soluble package comprises a PVOH film.

8. A kit according to claim 1 wherein the water soluble package comprises a cross-linking agent.

9. A kit according to claim 8 wherein the cross-linking agent is present in an amount from 0.05% to 9% by weight of the film.

10. A method of conditioning fabrics in a washing machine laundry treatment process comprising:
(i) dosing a water-soluble package containing a conditioning composition into a washing machine drum before the wash cycle commences
(ii) dosing an activator into a rinse compartment of the dispenser drawer of the washing machine before the rinse cycle commences,
(iii) operating the machine to provide a wash cycle followed by a rinse cycle so that at least part of the activator is transferred from the rinse compartment to the drum during the rinse cycle thereby causing and/or accelerating the disintegration of the water-soluble package during the rinse cycle and release of the conditioning composition therefrom; and
(iv) contacting the conditioning composition with fabrics during the rinse cycle.
